(19) United States
(12) Patent Application Publication
(10) Pub. No.: US 2026/0204191 A1
(43) Pub. Date: Jul. 16, 2026

(54) STORYTELLING DEVICE WITH HOLOGRAPHIC VISUAL COMPONENT AND METHOD OF USE THEREOF

(71) Applicant: Cleo L. Holmes, Chantilly, VA (US)

(72) Inventor: Cleo L. Holmes, Chantilly, VA (US)

(21) Appl. No.: 19/450,486

(22) Filed: Jan. 15, 2026

Related U.S. Application Data
(60) Provisional application No. 63/746,167, filed on Jan. 16, 2025.

(51) Int. Cl. G09G 3/00; G09B 5/06; H04R 1/02

(52) U.S. Cl. CPC G09G 3/003; H04R 1/028; G09B 5/06; H04R 2499/15

(57) ABSTRACT

A device configured to relay stories autonomously to one or more individuals via audible and visual mechanisms is disclosed. The device is equipped with at least one speaker, a programmable logic controller, a power source, memory containing at least one recording of at least one story, and a holographic display. The device is housed in a body exhibiting multiple modules, a top portion and a bottom portion. The modules, when combined, form the shape of a pyramid.

### CONTINUITY

This application is a non-provisional patent application of provisional patent application No. 63/746,167, filed on Jan. 16, 2025, and priority is claimed thereto.

### FIELD OF THE PRESENT INVENTION

The present invention relates to educational devices and methods of use thereof. More particularly, the present invention relates to educational toys designed to record and play audible recordings for individuals, particularly children, and which preferably includes a visual component.

### BACKGROUND OF THE PRESENT INVENTION

Conventionally, stories have been a reliable mechanism by which history is conveyed to youth. This is especially true for relaying the experiences and tales of deceased family members and friends, who are best memorialized by retelling their tales. Unfortunately, memories tend to fade over time, and it can become difficult to accurately retell the stories of those that have passed reliably once many years have passed. If there were a device which could easily convey these stories audibly, while being accompanied with a visual component, the memory of deceased friends and family could be more easily preserved.

Additionally, some concepts can be difficult to teach to children. As repetition is often the best means of achieving memorization of a story or event, it is often prudent to repeat the story multiple times. If there were a device which could facilitate the playback of important and/or historical stories multiple times, children would be more readily able to memorize and/or recall the stories told, and the storyteller need not tell the same story repetitively to achieve mastery. Further, if such a device could provide a visual component which was immersive and novel, such as a holographic display, the attention of children may be more adequately maintained for the duration of the story or lesson.

There have been previous devices that have been developed that record and play recorded sounds, songs, or spoken recordings. However, these devices fail to sufficiently stimulate growth, assist with education, and open communication channels for positive, successful outcomes.

Thus, there is a need for a new form of educational toy or education device configured to record and play audible recordings while stimulating growth, assisting with education, provoking thought and inquiry, and opening communication channels for positive, successful outcomes. Such a device is preferably configured to relay one or more stories to an audience, potentially including children. Such stories may encapsulate the experiences of a deceased loved one, such that their memory may endure beyond their passing.

A visual component, preferably enacted via a holographic display, is configured to accompany the audible storytelling aspect of the invention. Additional features and embodiments of the present general inventive concept will be apparent from the following detailed description and drawings.

### SUMMARY OF THE INVENTION

The present invention is a recording and playback device, configured to facilitate the dictation of stories audibly to an audience. The device further provides a visual component, preferably in the form of a holographic display, which enhances the storytelling capacity of the device. The device preferably exhibits the shape of a pyramid, and is equipped with a rechargeable power source to enable playback wirelessly. The holographic display is preferably disposed within a body of the device, or disposed on an exterior of the body. A programmable logic controller or similar processing unit, coupled to rewritable memory and in communication with at least one speaker, enables the device to play one or more specific stories to an audience. Some embodiments of the device are tailored towards educational use for children.

Further, other embodiments of the device are configured to function as a memorial and/or life history retelling device, enabling the memories of loved ones to be passed down from one generation to the next easily. The holographic display facilitates the depiction of images and/or videos in a three-dimensional context, further contributing to the immersion of the story being told by the device. Different stories may be uploaded to the device via at least one transceiver of the device if desired. Further, stories may be recorded directly to the device via at least one microphone present within the device.

### BRIEF DESCRIPTION OF DRAWINGS OF THE PRESENT INVENTION

The present invention will be better understood with reference to the appended drawing sheets, wherein:

FIG. 1 is a front perspective view of an educational toy according to an embodiment of the present inventive concept.

FIG. 2 is a flow chart detailing the method of use of the educational toy of the present invention.

### DETAILED DESCRIPTION OF THE PRESENT INVENTION

The present invention is a storytelling device, referenced as an educational toy (100), configured to convey stories via one or more audio-visual means, to an audience.

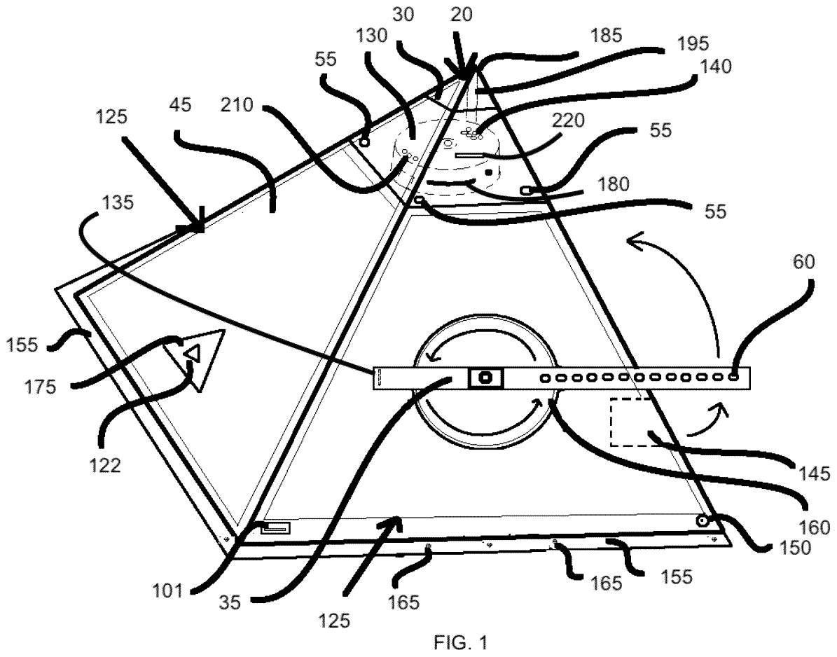

Referring to FIG. 1, the present invention, designated generally as (100), is illustrated. In the preferred embodiment, the educational toy (100) is designed and configured to stimulate growth, assist with education, provoke thought and inquiry and open communication channels for positive, successful outcomes. That is, the educational toy (100) is designed to enable the recording and playback of messages, lessons, songs, or other audible data to be played aloud to assist with educating young children by opening the channels of communication to support positive, successful outcomes. However, the present general inventive concept is not limited thereto. At the least, the present invention is configured to playback prerecorded stories and/or messages to convey information to individuals of an audience.

In the present embodiment, the educational toy (100) comprises a body (110) having two parts, a top (30) and a bottom (45) portion. The top portion (30) is removable from the bottom portion (45), and is preferably secured in position onto a top of the bottom portion (45) via magnets (55). The body (110) preferably includes four sides arranged in the shape of a pyramid. The body is approximately nine inches in height, approaching a point (20) at a top (30) of the body (110) in preferred embodiments. However, the body (110) may comprise different shapes and different sizes in alternate embodiments of the present invention, and the general inventive concept is not limited thereto.

Referring to FIG. 1, in the present embodiment, the body (110) includes a Universal Serial Bus (USB) port (101) for an electrical wire or plug to pass through an exterior of the body (110) if needed, or plug directly into the port disposed on the exterior of the body (110). However, the present general inventive concept is not limited thereto. That is, in alternative embodiments, the educational toy (100) may be powered and/or charged using conventional wireless charging technology, including, but not limited to, induction charging. The USB port (101) further enables the connection of the present invention to alternate drives, media, computers, and other mobile devices for optional wired data transfer.

The present invention includes an operating button (122) configured to activate a recording device (130) in a first configuration. Further, the operating button (122) is configured to activate an audible device, referenced as speaker (140), to play recorded messages, songs, lessons, or other recorded sounds or data which are saved to the memory of the recording device (130), or which are cast (or otherwise uploaded) to the present invention via the transceiver (180). In some alternate embodiments, multiple speakers (140) are present on or within the body (110) to facilitate stereo playback, and to enable audiences to equally hear the stories told by the device from any side of the device. An external speaker (145) may be present to more fully immerse the user in the audio playback.

The educational toy (100) preferably includes a holographic display (160), for example a projector configured to display a hologram. However, the present general inventive concept is not limited thereto.

The exemplary educational toy further includes a processor (180), memory, a speaker (140), a microphone (210), and a transceiver (220) such as a Bluetooth TM and/or WIFI radio, all in operative connection via at least one circuit. However, the present general inventive concept is not limited thereto.

In an exemplary embodiment, the educational toy (100) is configured to record a message, song, lesson, sound or other data by pressing the operating button (122) to activate the recording device (130). For example, the operating button (122) is pressed twice to activate the recording device (130) and begin recording. Once the recording device (130) is activated, the processor (180) operates in connection with the microphone (210) to receive the recording and store data corresponding to the recording in the memory (190). However, the present general inventive concept is not limited thereto.

When it is desired to play the recording, the operation button (122) is pressed again. For example, the operation button (122) is pressed once or held in the pressed position, or some other sequence or duration of time indicating to a “play recording” function. Once the operation button (122) has been pressed to indicate a desire to play the recording, the processor (180) operates in connection with the speaker (140) to play an audible version of the recording. However, the present general inventive concept is not limited thereto. It should be noted that the operation button (122) need not be disposed on the side of the body (110) as shown in FIG. 1, and may instead be disposed anywhere else on the body (110) in alternate embodiments of the present invention.

To accompany the audible version of the recording emanating from the speaker (140), the holographic display (160) of the present invention is preferably activated. The holographic display (160) is preferably configured to relay visual data, including but not limited to photos, graphs, and/or statistics relating to the story told. For example, a holographic photo of the subject of the story may be represented on the holographic display. In many cases, the subject of the story is a deceased family member or family friend.

In preferred embodiments of the present invention, software is included and is preinstalled to the recording device. The exemplary software is preferably stored on the memory of the present invention. Alternately, the software is stored on a remote server or on a cloud-based storage system. The exemplary software comprises processor executable code that, when executed, is configured to perform the functions, methods, and operations discussed herein. The software is accessible by and executable by a processor of a remote electronic device such as, but not limited to, a smart phone in some embodiments of the present invention. However, the present general inventive concept is not limited thereto, as it may be self-contained. The software is preferably configured to drive holographic playback of images and/or video on the holographic display (160), which employs at least one Light Emitting Diode (LED) (30) disposed on a rotary fan (35). The fan (35) is motor driven, and while spinning, the at least one LED (60) pulses in accordance with instructions provided by the software to present an oscillatory moving image akin to a holographic display as is presently known in the art.

In such embodiments, a user may access the software on their remote electronic device and use the software along with a microphone of the device to record a message, song, lesson, or other sound or data. The user may then cause the software to transmit data corresponding to the recording to the transceiver (220) of the present invention. Upon receipt of the recording by the transceiver (220), the processor (180) in operation with the memory is configured to store the data corresponding the recording. In the manner previously discussed, a child may play the recording by pressing the operating button (122) indicating “play recording” to cause the speaker (140) to play an audible version of the recording. However, the present general inventive concept is not limited thereto.

It should be understood that, in preferred embodiments of the present invention, the top (30) of the body (110) is removable, exposing the primary playback device equipped with the speaker (140), microphone (210), and transceiver (220) as shown in FIG. 1. The top (30) is multifunctional, exhibiting a top button (185) which is supported and activated via a shaft (195) which extends to the recording and playback assembly (130).

In alternative embodiments, the educational toy (100) may include multiple operating buttons, one for “record” and one for “play recording.”

In alternative embodiments, the educational toy (100) includes a camera and a display screen. In such embodiments, the exemplary display screen of the present invention is configured to display video recorded via the camera. The educational toy (100) is configured to store and receive data corresponding to recorded video.

In all preferred embodiments, the educational toy (100) further includes a power supply. The exemplary power supply may comprise a battery or a plug in for a household AC power supply. A female power port (150), such as the barrel plug depicted in FIG. 1, may be employed to convey power to the device and charge the battery. Alternately, the present invention may be charged via a USB connection to the USB port (101).

In alternative embodiments, the educational toy (100) is configured to receive data downloaded from the internet or purchased via a software application store, and to store such data to be played by the child. Further, it is envisioned that some embodiments of the present invention may be equipped with a local or cloud-based Artificial Intelligence (AI) interface which facilitates operation of the device. Such an AI-enabled interface may also enable conversation between the user and the device, and enable the user to dictate, via voice, what is played (either audio, holographic video, or both) on the device.

Although a few exemplary embodiments of the present general inventive concept have been illustrated and described, it will be appreciated by those skilled in the art that changes may be made in these exemplary embodiments, and the features and relationships discussed herein may be combined to form additional embodiments, without departing from the principles and spirit of the general inventive concept, the scope of which is defined in the appended claims and their equivalents.

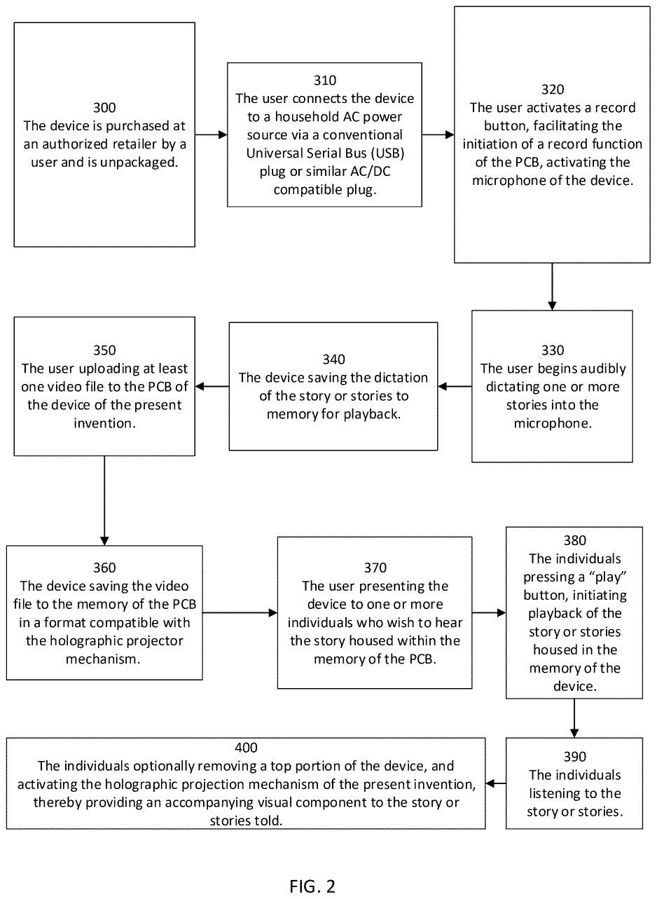

It should be understood that the method of use of the device of the present invention, as shown in FIG. 2, is preferably as follows:
1. The device is purchased at an authorized retailer by a user and is unpackaged. (300)
2. The user connects the device to a household AC power source via a conventional Universal Serial Bus (USB) plug or similar AC/DC compatible plug. (310)
3. The user activates a record button, facilitating the initiation of a record function of the PCB, activating the microphone of the device. (320)
4. The user begins audibly dictating one or more stories into the microphone. (330)
5. The device saving the dictation of the story or stories to memory for playback. (340)
6. The user uploading at least one video file to the PCB of the device of the present invention. (350) The video must be compatible with playback over the holographic display mechanism of the present invention.
7. The device saving the video file to the memory of the PCB in a format compatible with the holographic display. (360)
8. The user presenting the device to one or more individuals who wish to hear the story housed within the memory of the PCB. (370)
9. The individual pressing a “play” button, initiating playback of the story or stories housed in the memory of the device. (380)
10. The individuals listening to the story or stories. (390)
11. The individuals optionally removing a top portion of the device, and activating the holographic display mechanism of the present invention, thereby providing an accompanying visual component to the story or stories told. (400)

The stories dictated may or may not include stories from deceased loved ones or family members, recorded years ago. Alternately, the stories may include historical accounts of local, national, or international events which are conveyed in a meaningful and engaging manner, accompanied with the holographic images/videos.

It should be noted that the integration of Artificial Intelligence (AI) may be present in some embodiments of the present invention. In such embodiments, adequate filters are present within the components of the system that ensure that personal information of clients and customers are not shared beyond the onboard storage of the present invention itself.

Further in some alternate embodiments of the present invention, speakers of the present invention may be configured to emit nature sounds such as the sounds of rain drops, ocean waves, chirping birds, and other similar sounds upon request by the user to help calm the user and/or assist in sleep.

Additionally, some embodiments of the present invention are preferably equipped with an onboard power source (battery), facilitating use of the present invention on-the-go, during travel such as in a vehicle for use by passengers. Such embodiments may preferably be connected to the power supply of the vehicle to charge the battery for continued use.

In further embodiments of the present invention, the holographic display assembly (160) is mechanically secured to a supporting base board (155) to enhance stability and improve safety, particularly for use by children. In one exemplary embodiment, a mounting bracket having a length of approximately three and one-half (3.5) inches is fixed to a lower surface of the holographic display assembly (160). The mounting bracket is configured to engage the base board (155) having an approximate thickness of one (1) inch. The mounting bracket is secured to the base board using two (2) mechanical fasteners, such as one-half (0.5) inch screws. This mounting configuration reduces the likelihood of tipping or unintended displacement of the device during use, thereby addressing child safety considerations. The base board may be formed of wood, polymeric material, composite material, or other rigid substrate, and is not required to be illustrated or numbered in the accompanying drawings.

The holographic display assembly (160) is powered via a Universal Serial Bus (USB) connection. In some embodiments, the connection supplies power from an external alternating current (AC) wall adapter, while in other embodiments power is supplied directly from a computing device. The external power adapter may be configured to accept an input voltage in the range of approximately 110 to 240 volts AC and convert the same to a suitable direct current (DC) output voltage.

In certain embodiments, the device further comprises one or more electrically switchable smart film sheets (125) configured to selectively transition between a transparent state and an opaque state. This feature is accessible via the smart film button (175). The smart film is electrically coupled to the operating button (122). Upon actuation of the operating button (122), an electrical signal is applied to the smart film, causing suspended particles within the film to align or disperse, thereby changing the optical properties of the film from transparent to opaque, or vice versa. The smart film sheets (125) preferably requires an external voltage source to effect this transition.

In a preferred embodiment, five (5) smart film sheets (125) are provided, each having an approximate thickness of two (2) millimeters. The smart film sheets (125) may be fabricated from acrylic, polycarbonate, or similar optically transmissive materials, and are affixed using a clear adhesive tape or other transparent bonding medium. Four (4) of the smart film sheets (125) are positioned along interior walls of the lower body portion (45), and one (1) sheet is positioned across a shelf portion of the lower body (45) configured to support the recording and playback assembly (130). When energized, the smart film sheets (125) render the interior surfaces of the pyramid-shaped body visually opaque, thereby enhancing the holographic visual effect. The smart film sheets (125) are powered via a direct connection to an external AC/DC power source.

In additional embodiments, the lower body portion (45) is secured to the base board using two (2) fasteners, referenced as screws (165) positioned at opposing corners of the lower body (45). This attachment method allows selective access to a removable memory interface located beneath a rear portion of the rotary fan assembly (35). In one embodiment, the removable memory interface comprises a MicroSD card slot (135), configured to receive user-supplied removable storage media. Users may insert their own MicroSD cards containing compatible audio and/or video files for playback by the device.

In further embodiments, the storytelling device includes an embedded audio playback system configured to provide synchronized sound output in conjunction with holographic video playback. Audio may be delivered by pairing the rotary fan holographic display assembly (35) with an external tablet, smartphone, or display device that provides audio output, while the holographic display assembly (35) renders the corresponding video imagery.

In some embodiments, the device further includes an integrated multimedia playback module configured to support digital video file formats, including but not limited to MP4 files encoded using H.264 and/or H.265 compression standards. This configuration enhances audio-visual synchronization and improves playback efficiency.

Additionally, the embedded system is configured to record and playback audio data associated with the recording and playback assembly (130). Recorded audio may be stored in onboard memory or removable storage media and replayed through the device's speaker system in coordination with holographic visual content. A remote control is preferably present as a companion accessory to preferred embodiments of the present invention. The remote control is capable of facilitating MP3/MP4 playback manipulation, as well as operation of the holographic display.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A storytelling device with a holographic visual component, the device comprising:
a body, said body equipped with a speaker, a microphone, memory, a processor, and a transceiver disposed within said body;
an operating button, said operating button dispose on an exterior of said body;
at least one light emitting diode (LED) disposed on a rotary fan to facilitate the playback of images and/or video on the holographic visual component; and
wherein the device is configured to play audio-visual stories from said memory via said speakers and the holographic visual component.
